(19) United States
(12) Patent Application Publication
(10) Pub. No.: US 2024/0340925 A1
(43) Pub. Date: Oct. 10, 2024

(54) METHODS AND SYSTEMS FOR DEVICE-TO-DEVICE POSITIONING

(71) Applicant: ZTE Corporation, Shenzhen (CN)

(72) Inventors: Junpeng LOU, Shenzhen (CN); Chuangxin JIANG, Shenzhen (CN); Juan LIU, Shenzhen (CN); Haigang HE, Shenzhen (CN); Jie CHEN, Shenzhen (CN)

(21) Appl. No.: 18/749,216

(22) Filed: Jun. 20, 2024

Related U.S. Application Data
(63) Continuation of application No. PCT/CN2022/085711, filed on Apr. 8, 2022.

(51) Int. Cl. H04W 72/25; H04W 64/00

(52) U.S. Cl. CPC H04W 72/25; H04W 64/00

(57) ABSTRACT

Methods and systems for techniques for device-to-device positioning are disclosed. In an implementation, a method of wireless communication includes performing, by a wireless device, a device-to-device communication according to one or more device-to-device positioning reference signals having a relationship with at least one of a set of resources, control information including at least one of device-to-device control information or device-to-device positioning control information, or device-to-device communication channel.

### CROSS-REFERENCE TO RELATED APPLICATION

This application is a continuation and claims priority to International Application No. PCT/CN2022/085711, filed on Apr. 8, 2022, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for device-to-device positioning.

In one aspect, a method of data communication is disclosed. The method includes performing, by a wireless device, a device-to-device communication according to one or more device-to-device positioning reference signals having a relationship with at least one of a set of resources, control information including at least one of device-to-device control information or device-to-device positioning control information, or device-to-device communication channel.

In another aspect, a method of data communication is disclosed. The method includes monitoring, by a wireless device, a device-to-device sensing window include at least one of a device-to-device data communication sensing window, or a device-to-device positioning reference signal sensing window that has a relationship with a device-to-device data communication sensing window, and performing, by the wireless device, a reference signal sensing operation using the device-to-device positioning reference signal sensing window.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of SL PRS that is in a SL resource pool.

FIG. 4 shows a situation where PRS exceeds the resource pool from the higher frequency side.

FIG. 5 shows a situation where PRS exceeds the resource pool from the lower frequency side.

FIG. 6A shows more than one SCI_P or SPCI (e.g., indication information) indicate a PRS. FIG. 6B shows one SCI_P or SPCI (e.g., indication information) in each resource pool indicates the corresponding part of a PRS.

FIG. 7 shows a situation where PRS exceeds SL resource pool, and SCPI indication case.

FIG. 8 shows a special frequency band that is used as a transmission band (resource pool) of SCI_P.

FIG. 9 shows a partial SL resource pool that is used (or reused) as transmission band (resource pool) of SCI_P.

FIG. 10 shows a separate SL resource pool that is used as a transmission band (resource pool) of SCI_P.

FIG. 11 shows a PRS for an unlicensed band.

FIG. 12 shows all PRS repetitions with SCI_P indication.

FIG. 13 shows only the first PRS repetitions with SCI_P indication.

FIG. 14 shows cach PRS cycle with SCI_P indication.

FIG. 15 shows every three PRS cycles with one SCI_P indication.

FIG. 16 shows a permutation combination scheme.

FIG. 17 shows a frequency hopping indication of SCI_P.

FIG. 18A shows windows of SL PRS mode 2 resource selection method. FIG. 18B shows a PRS sensing window. FIG. 18C shows a plurality of portions of a PRS sensing window.

FIG. 19 shows an example of a process for wireless communication based on some example embodiments of the disclosed technology.

FIG. 20 shows another example of a process for wireless communication based on some example embodiments of the disclosed technology.

### DETAILED DESCRIPTION

Section headings are used in the present document only for case of understanding and do not limit scope of the embodiments to the section in which they are described. Furthermore, while embodiments are described with reference to 5G examples, the disclosed techniques may be applied to wireless systems that use protocols other than 5G or 3GPP protocols.

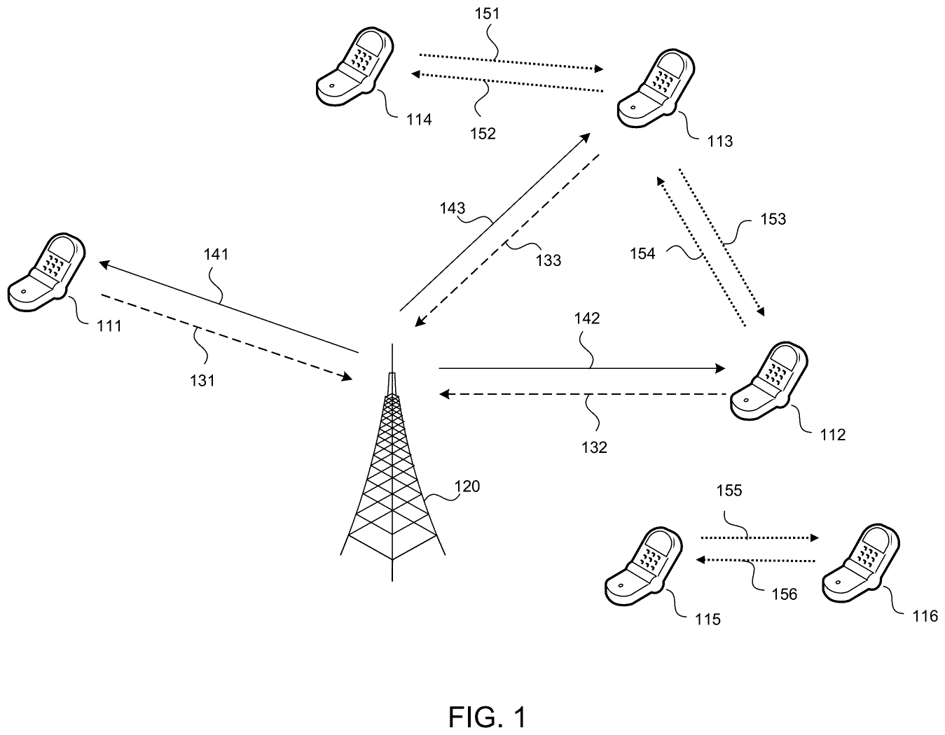

FIG. 1 shows an example of a wireless communication system (e.g., a long term evolution (LTE), 5G or NR cellular network) that includes a BS 120 and one or more user equipment (UE) 111, 112, 113, and 114. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. In some embodiments, UE (e.g., 112, 113, 114, 115, 116) can connect directly to another UE (e.g., 112, 113, 114, 115, 116) using device-to-device or sidelink communications (151, 152, 153, 154, 155, 156) without relaying their data via the BS 120. The UE may be, for example, a smartphone, a tablet, a mobile computer, a machine to machine (M2M) device, a terminal, a mobile device, an Internet of Things (IoT) device, and so on.

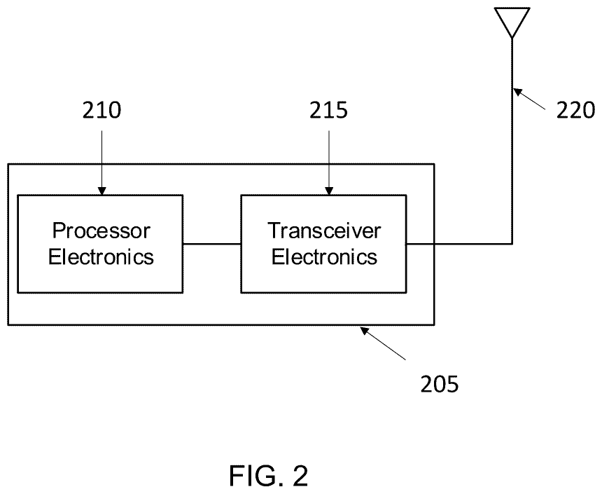

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

In performing sidelink positioning operations, positioning reference signals (PRSs) in New Radio (NR) are scheduled by a base station (BS). However, there are some issues when transmitting and receiving PRS in a sidelink position.

The fifth generation (5G) mobile networks with enhanced connectivity play an increasingly important role in the development of positioning techniques such as device-to-device positioning techniques. Many studies are being carried out to improve the accuracy of the positioning techniques. 3GPP Rel-18 study items are as below.

TABLE 1
RAN#94 for Rel-18 positioning

| ● | Study and evaluate performance and feasibility of potential | |
|---|---|---|
| | solutions for SL positioning, considering relative positioning, | |
| | ranging and absolute positioning: [RAN1, RAN2] | |
| | ◯ | Evaluate bandwidth requirement needed to meet the |
| | | identified accuracy requirements [RAN1] |
| | ◯ | Study of positioning methods (e.g., TDOA, RTT, |
| | | AOA/D, etc.) including combination of SL positioning |
| | | measurements with other RAT dependent positioning |
| | | measurements (e.g., Uu based measurements) [RAN1] |
| | ◯ | Study of sidelink reference signals for positioning |
| | | purposes from physical layer perspective, including signal |
| | | design, resource allocation, measurements, associated |
| | | procedures, etc., reusing existing reference signals, |
| | | procedures, etc. from sidelink communication and from |
| | | positioning as much as possible [RAN1] |
| | ◯ | Study of positioning architecture and signaling |
| | | procedures (e.g., configuration, measurement reporting, |
| | | etc.) to enable sidelink positioning covering both UE |
| | | based and network based positioning [RAN2, including |
| | | coordination and alignment with RAN3 and SA2 as |
| | | required] |

Note: When the bandwidth requirements have been determined and
the study of sidelink communication in unlicensed spectrum has
progressed, it can be reviewed whether unlicensed spectrum can be
considered in further work. Checkpoint at RAN#97 to see if
sufficient information is available for this review.

In Table 1 above, “AoA” stands for Angle of Arrival, “TDoA” stands for Time Difference of Arrival, and “RTT” stands for multi-round trip time.

RAN 1 for Rel-17 positioning provides the PRS of NR position. In addition, the current standard (e.g., 38.214) provides the sensing window and resource selection of sidelink (SL) as below.

TABLE 2
RAN 1 for Rel-17 positioning, 38.214

The following steps are used:

| 1) | A candidate single-slot resource for transmission Rx,y is defined as a set of L_{subCH} | |
|---|---|---|
| | contiguous sub-channels with sub-channel x+j in slot t′_{y}^{SL} where j = 0, ... , L_{subCH} − 1. | |
| | The UE shall assume that any set of L_{subCH} contiguous sub-channels included in the | |
| | corresponding resource pool within the time interval [n + T₁, n + T₂] correspond to one | |
| | candidate single-slot resource, where | |
| | - | selection of T₁ is up to UE implementation under 0 ≤ T₁ ≤ T_{proc,1}^{SL}, where T_{proc,1}^{SL} is |
| | | defined in slots in Table 8.1.4-2 where μ_{SL} is the SCS configuration of the SL BWP; |
| | - | if T₂ₘᵢₙ is shorter than the remaining packet delay budget (in slots) then T₂ is up to UE |
| | | implementation subject to T₂ₘᵢₙ ≤ T₂ ≤ remaining packet delay budget (in slots); |
| | | otherwise T₂ is set to the remaining packet delay budget (in slots). |
| | The total number of candidate single-slot resources is denoted by Mₜₒₜₐₗ. | |
| 2) | The sensing window is defined by the range of slots [n − T₀, n − T_{proc,0}^{SL}) where T₀ is | |
| | defined above and T_{proc,0}^{SL} is defined in slots in Table 8.1.4-1 where μ_{SL} is the SCS | |
| | configuration of the SL BWP. The UE shall monitor slots which belongs to a sidelink | |
| | resource pool within the sensing window except for those in which its own transmissions | |
| | occur. The UE shall perform the behavior in the following steps based on PSCCH decoded | |
| | and RSRP measured in these slots. | |
| 3) | The internal parameter Th(pᵢ, Pⱼ) is set to the corresponding value of RSRP threshold | |
| | indicated by the i-th field in sl-Thres-RSRP-List, where i = pᵢ + (pⱼ − 1) * 8. | |
| 4) | The set S_{A} is initialized to the set of all the candidate single-slot resources. | |
| 5) | The UE shall exclude any candidate single-slot resource R_{x,y} from the set S_{A} if it meets all | |
| | the following conditions: | |
| | - | the UE has not monitored slot t′ₘ^{SL} in Step 2. |
| | - | for any periodicity value allowed by the higher layer parameter |
| | | sl-ResourceReservePeriodList and a hypothetical SCI format 1-A received in slot t′ₘ^{SL} |
| | | with ‘Resource reservation period’ field set to that periodicity value and indicating all |
| | | subchannels of the resource pool in this slot, condition c in step 6 would be met. |
| 5a) | If the number of candidate single-slot resources R_{x,y} remaining in the set S_{A} is smaller | |
| | than X · Mₜₒₜₐₗ, the set S_{A} is initialized to the set of all the candidate single-slot resources | |
| | as in step 4. | |
| 6) | The UE shall exclude any candidate single-slot resource R_{x,y} from the set S_{A} if it meets all | |
| | the following conditions: | |
| | a) | the UE receives an SCI format 1-A in slot t′ₘ^{SL}, and ‘Resource reservation period’ field, |
| | | if present, and ‘Priority’ field in the received SCI format 1-A indicate the values Pᵣₛᵥₚ_RX |
| | | and prio_{RX}, respectively according to Clause 16.4 in [6, TS 38.213]; |
| | b) | the RSRP measurement performed, according to clause 8.4.2.1 for the received SCI |
| | | format 1-A, is higher than Th(prio_{RX}, prio_{TX}); |
| | c) | the SCI format received in slot t′ₘ^{SL} or the same SCI format which, if and only if the |
| | | ‘Resource reservation period’ field is present in the received SCI format 1-A, is |
| | | $assumed to be received in slot ( s ) {t}_{m + q \times {P}_{rsvp \_ RX}^{′}}^{′ SL} determines according to clause 8.1 \text{.5}$ |
| | | $the set of resource blocks and slots which overlaps with {R}_{x , y + j \times {P}_{rsvp \_ TX}^{′}} for q = 1 , 2 , … ,$ |
| | | Q and j=0, 1, ... , Cᵣₑₛₑₗ − 1. Here, P′ᵣₛᵥₚ_RX is Pᵣₛᵥₚ_RX converted to units of logical |
| | | $slots according to clause 8.1 \text{.7} , Q = ⌈ \frac{{T}_{scal}}{{P}_{rsvp \_ RX}} ⌉ if {P}_{rsvp \_ RX} < {T}_{scal} and {n}^{′} - m \leq$ |
| | | P′ᵣₛᵥₚ_RX, where t′_{n′}^{SL} = n if slot n belongs to the set (t′₀^{SL}, t′₁^{SL}, . . . , t′_{T′}_{ₘₐₓ}_{- 1}^{SL}), |
| | | otherwise slot t′_{n′}^{SL} is the first slot after slot n belonging to the set |
| | | (t′₀^{SL}, t′₁^{SL}, . . . , t′_{T′}_{ₘₐₓ}_{- 1}^{SL}); otherwise Q = 1. Tscal is set to selection window size T₂ |
| | | converted to units of msec. |

| | |
|---|---|
| 7) | If the number of candidate single-slot resources remaining in the set S_{A} is smaller than X . |
| | Mₜₒₜₐₗ, then Th(pᵢ, pⱼ) is increased by 3 dB for each priority value Th(pi, pⱼ) and the |
| | procedure continues with step 4. |

The UE shall report set S_{A} to higher layers.

### Example Embodiment 1: SCI_P Design to Indicate SL-PRS

The disclosed technology can be implemented in some embodiments to sense, detect or monitor sidelink control information (e.g., SCI_P) indicating SL PRS by the original terminal and/or the original sidelink control information (SL SCI) by other terminals. To ensure a successful monitoring of the sidelink control information, the following schemes can be used based on some implementations of the disclosed technology.

Case 1: Add an indication of Sidelink Positioning Reference Signal (SL PRS) to SL SCI including 1^{st}-stage SCI and/or 2^{nd}-stage SCI.

Examples of the indication of SL PRS may include at least one of: whether SL PRS is transmitted periodically; the period or cycle of SL PRS; the number of repetitions of SL PRS; and the time-frequency domain position of SL PRS; the pattern of SL PRS.

Case 2: Reuse SCI format 1-A and change the domain indicating Physical Sidelink Control Channel/Physical Sidelink Shared Channel (PSCCH/PSSCH) in SCI structure to relevant information indicating SL PRS.

In an implementation, a frequency resource assignment, a time resource assignment and a resource reservation period may be used to indicate the frequency and/or time domain resources of SL PRS and the resource reservation period of PRS, respectively.

In addition, 1 bit reserved in SCI format 1-A can be used to indicate whether the SCI indicates PSSCH or SL PRS.

Some fields in SCI format 1-A that are not used in SL PRS can also be reused to implicitly indicate that the SCI indicating SL PRS or PSSCH.

In an implementation, assuming that the transmission of PRS is occupied by a full resource pool or a full bandwidth, the special value of a frequency resource assignment field can be used. For example, this field is identified by all 0, indicating PRS in the current configuration.

In another implementation, if the SL PRS in 32 slots and the maximum retransmission are demanded only one time, the SCI_P of SL PRS can be distinguished by the bit saved by the time resource assignment.

TABLE 3

| | |
|---|---|
| - | $Frequency resource assignment - ⌈ {log}_{2} ( \frac{{N}_{subChannel}^{SL} ( {N}_{subChamel}^{SL} + 1 )}{2} ) ⌉ bits when the value of the$ |
| | higher layer parameter sl-MaxNumPerReserve is configured to 2; otherwise |
| | $⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer$ |
| | parameter sl-MaxNumPerReserve is configured to 3, as defined in clause 8.1.5 of [6, TS 38.214]. |
| - | Time resource assignment - 5 bits when the value of the higher layer parameter sl- |
| | MaxNumPerReserve is configured to 2; otherwise 9 bits when the value of the higher layer |
| | parameter sl-MaxNumPerReserve is configured to 3, as defined in clause 8.1.5 of [6, TS 38.214]. |
| - | Resource reservation period -┌log₂ Nᵣₛᵥ_period┐ bits as defined in clause 16.4 of [5, TS 38.213], |
| | where Nᵣₛᵥ_period is the number of entries in the higher layer parameter sl-ResourceReservePeriodList, |
| | if higher layer parameter sl-MultiReserveResource is configured; 0 bit otherwise. |
| ... | |
| - | Reserved - a number of bits as determined by higher layer parameter sl-NumReservedBits, |
| | with value set to zero. |

In some implementations, the reference signals involved in SL positioning, such as positioning reference signal, are referred to as PRS or SL PRS.

In some implementations, the PRS indication can be SL SCI or position reference information, or other indication information, which can be referred to as SCI_P or SPCI. In other word, the SPCI may be SCI or include SCI that indicates PRS or PSSCH and SL positioning control information. In some implementations, SPCI is a broader concept including SCI.

The time-frequency domain relationship between SCI_P and PRS can be time division based and/or frequency division based, etc. In this patent document, the time division based relationship will be discussed.

### Example Embodiment 2: SCI_P Indicating SL-PRS in Different Frequency Domain Ranges

Case 1: SL PRS is in a SL resource pool

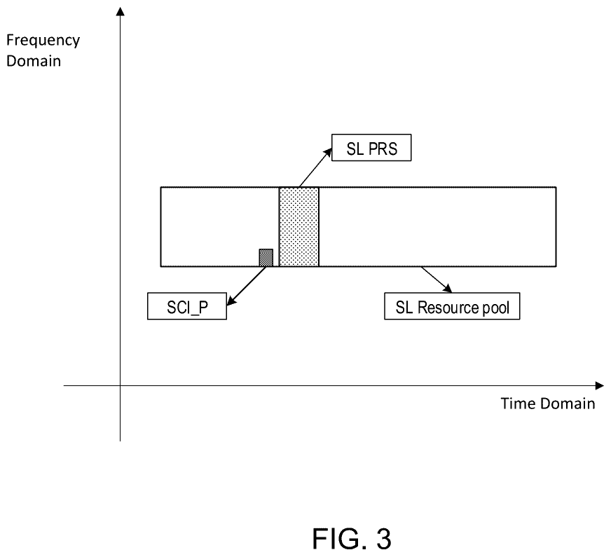

FIG. 3 shows an example of SL PRS that is in a SL resource pool.

Case 1.1: If the frequency range of SL PRS does not exceed the frequency range of SL resource pool, an SL PRS can be indicated by one or more indication information segments (such as SCI_P, etc.) in the resource pool. In some implementations, the term “resource pool” can be used to indicate a set of resources or a resource set.

Case 1.2: If the frequency range of SL PRS does not exceed the frequency range of SL resource pool, the SL PRS can be a transmission without additional SCI_P indications.

For example, the SL PRS can be bound to PSCCH/PSSCH. The transmission ratio of a fixed configuration data PSSCH to PRS is n:m. That is, a transmission n PSSCH slots corresponds to the transmission of m SL PRS. This may also be referred to as “PRS pattern.”

Case 1.3: Whether to indicate SL PRS or part of PRS is determined according to the channel busy ratio (CBR)/channel occupancy ratio (CR) measurements of the current resource pool and/or other information associated with each resource pool or an indication of high-level signaling. If the current resource pool is in a relatively idle state, SL PRS can be transmitted without any indication, because the collision probability between SL PRS and PSCCH/PSSCH is very low.

Case 2: SL PRS frequency domain exceeds one SL resource pool

Case 1 of Example Embodiment 2 describes whether and how to SL PRS in an SL resource pool indicated by SCI_P. If the frequency domain range of PRS exceeds the bandwidth of SL resource pool, various schemes about one resource pool (or resource set or a set of resources) can be applied to all resource pools in contact with PRS on a frequency domain.

Case 2.1: Various possible situations of SL PRS exceeding the frequency domain of resource pool (or resource set or a set of resources).

Case 2.1.1: PRS exceeds the resource pool from a higher frequency side.

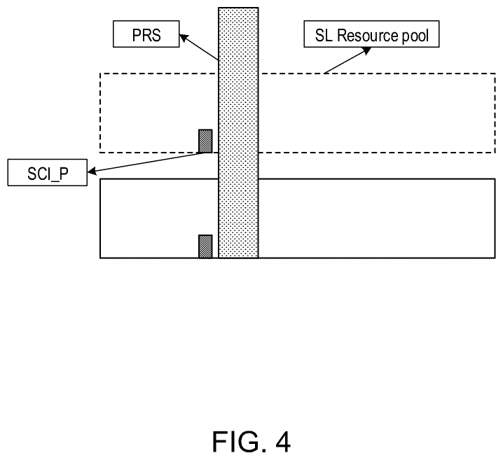

FIG. 4 shows a situation where PRS exceeds the resource pool from the higher frequency side.

Case 2.1.2: PRS exceeds the resource pool from a lower frequency side.

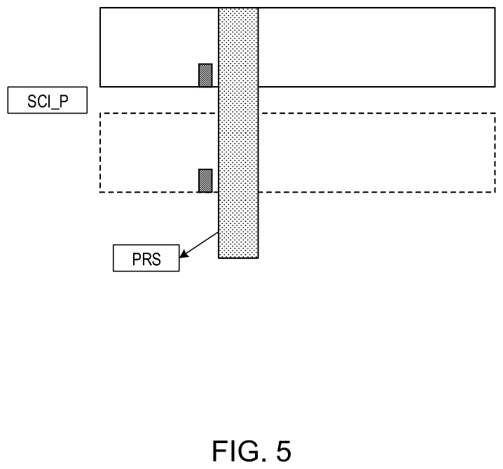

FIG. 5 shows a situation where PRS exceeds the resource pool from the lower frequency side.

Case 2.1.3 PRS exceeds the resource pool from both higher and lower frequency sides.

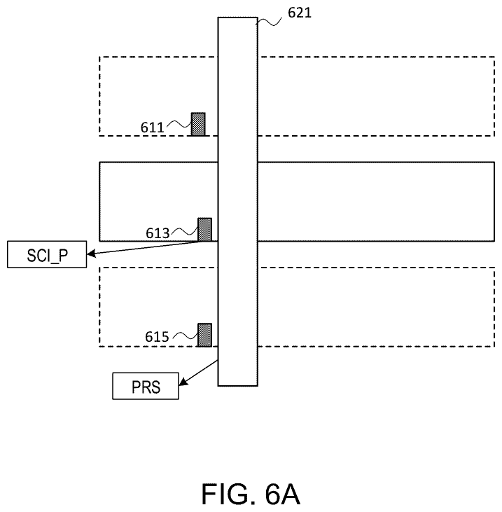

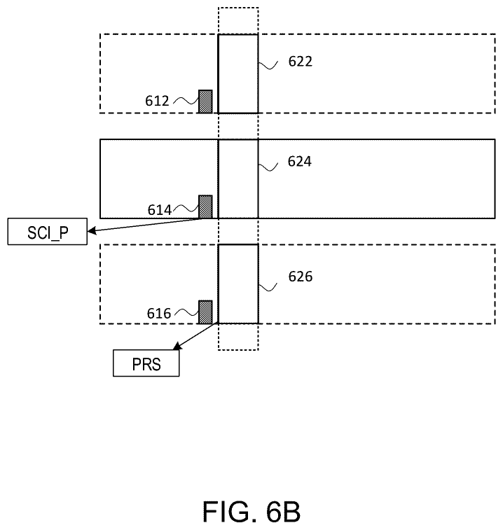

FIG. 6A shows more than one SCI_P or SPCI (e.g., indication information) indicate a PRS. FIG. 6B shows one SCI_P or SPCI (e.g., indication information) in each resource pool indicates the corresponding part of a PRS.

Case2.2: SL SPCI operates uniformly or separately in each resource pool

Taking SL PRS extending from the low-frequency and high-frequency directions of a resource pool and touching a resource pool at both ends as an example, the disclosed technology can be implemented in some embodiments to apply the scheme of SL PRS uniformly or separately to each resource pool.

Case2.2.1: If PRS exceeds an SL resource pool, one or more instructions for SL PRS (such as SCI_P, etc.) can be used for each resource pool (See e.g., FIG. 6).

Case2.2.2: If PRS exceeds an SL resource pool, the indication scheme for PRS can be applied to each resource pool separately.

In some implementations, one or more pieces of indication information (such as SCI_P, etc.) can be used in each resource pool in various situations in which SL PRS exceeds the frequency domain of a resource pool.

One or more pieces of indication information can indicate a PRS or the different part of a PRS in each resource pool.

Referring to FIG. 6A, a plurality of SCI_Ps (or SPCIs) 611, 613, 615 indicate a PRS 621. Referring to FIG. 6B, SCI_P (or SPCI) 612 indicates a portion 622 of a PRS, SCI_P (or

SPCI) 614 indicates a portion 624 of the PRS, and SCI_P (or SPCI) 616 indicates a portion 626 of the PRS.

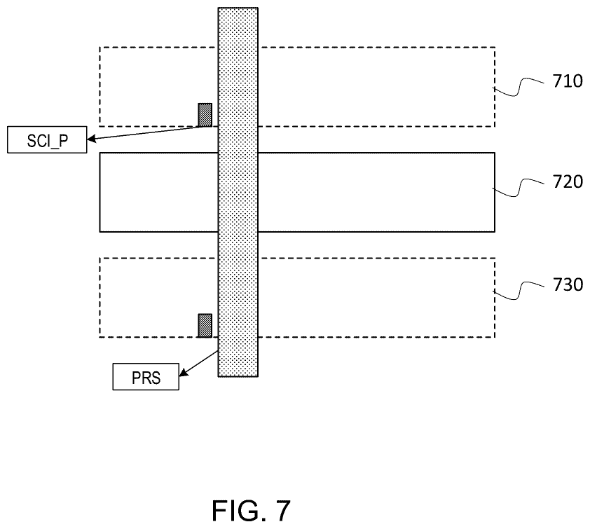

As shown in FIG. 7, one or more schemes for SL PRS indication information (such as SCI_P, etc.) can be applied to a first resource pool 710. A second resource pool 720 between the first resource pool 710 and a third (e.g., the last) resource pool 730 can be considered “idle” and no indication information for SL PRS is provided.

In some implementations, the CBR/CR measurements or other information associated with each resource pool or an indication of high-level signaling to the resource pools can be used to determine which resource pool(s) the indication information can be applied to. In one example, a resource pool is selected and the indication information of PRS is added to a set of resource pools involved in the PRS frequency domain, and the corresponding indication information is applied to the set of resource pools.

Case2.3: The indication information of SL PRS is sent separately in one or more frequency bands (e.g., resource pool). In some implementations, a special resource pool and/or multiple resource pools can be used for SL PRS indication information.

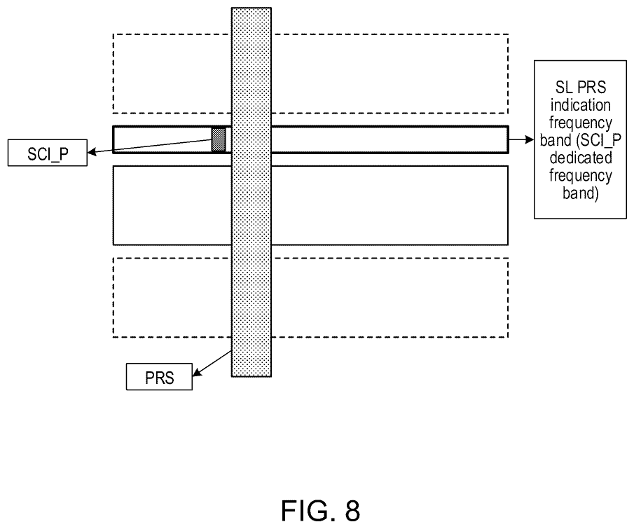

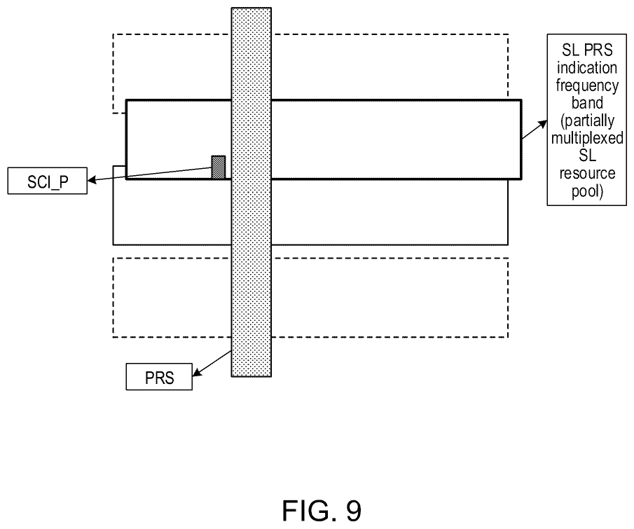

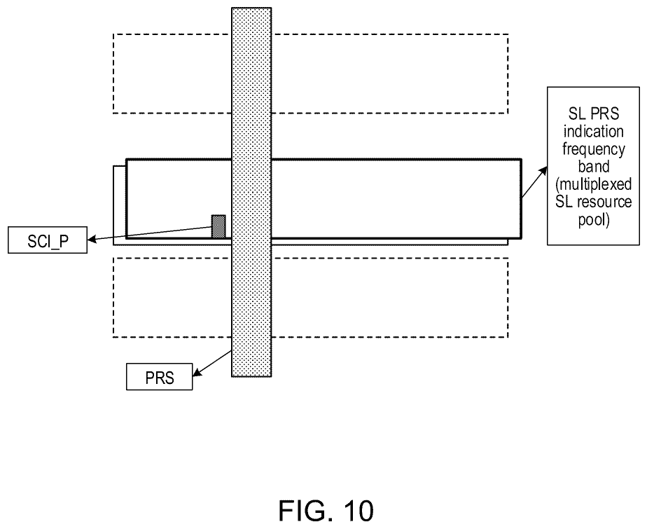

FIG. 8 shows a special frequency band that is used as a transmission band (resource pool) of SCI_P. FIG. 9 shows a partial SL resource pool that is used (or reused) as transmission band (resource pool) of SCI_P. FIG. 10 shows a separate SL resource pool that is used as a transmission band (resource pool) of SCI_P.

In some implementations, one or more reference/baseline frequency band ranges (e.g., resource pool) in the range involved in SL PRS frequency domain can be selected. The time-frequency domain position and other information of SL PRS can be obtained by blind detection of SCI_P in the one or more selected frequency band ranges. The one or more selected frequency band ranges can be a separate SL resource pool (as shown in FIG. 8), or a part of the SL resource pool combined non resource pool range (as shown in FIG. 9), or a frequency band range completely independent of the SL resource pool (as shown in FIG. 10) and SCI_P is transmitted only within this frequency band range.

The frequency band range of different PRSs in the whole bandwidth are different, and the parameters of SCI_P, such as the range and the number of reference frequency bands also could be changed flexibly. The specific frequency domain range or the number of reference frequency bands and other parameters can be directly or implicitly notified to communication equipment and devices through a pre-configuration or a high-level signaling indication.

Case 3: SL PRS in non ITS band

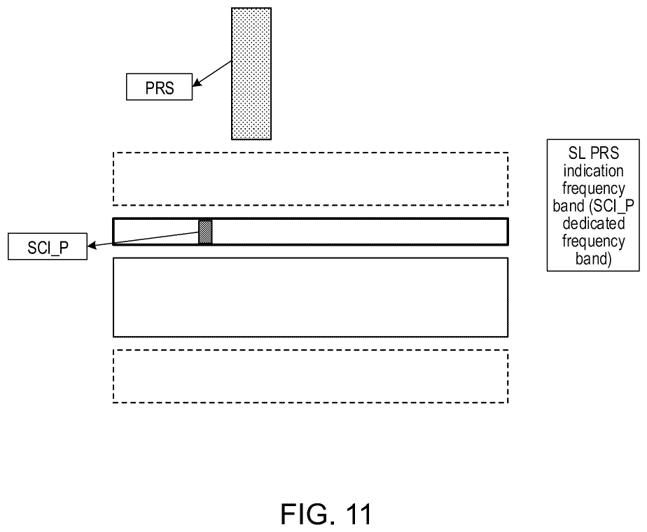

FIG. 11 shows a PRS for an unlicensed band.

In some implementations, SL PRS or NR PRS may be configured in an unlicensed spectrum, and indicated by SCI_P/PRS, or NR uplink and downlink related information. The signals could corm from licensed and/or unlicensed band. The frequency band of PRS can be obtained by pre-configuration, and or RRC signaling, and or MAC CE, and or SCI and or DCI and etc.

Taking SL PRS as an example, if the PRS is in an unlicensed band, the schemes discussed with respect to the cases of the embodiments discussed in this patent document are also applied. In some implementations, SCI_P takes the special frequency band. As shown in FIG. 11, PRS and SL resource pools do not overlap with each other on a frequency domain, and PRS can be regarded as the unauthorized frequency band adopted in NR-U. In some implementations, SCI_P can still indicate PRS related information.

### Example Embodiment 3: Repetition or Cycle of PRS Transmission, and Whether to Use SCI_P to Indicate

When transmitting SL PSSCH, the SL SCI will be also transmitted in the slot, but SL PRS transmission may not necessarily bound to SCI_P.

It is to be noted that this embodiment only takes PRS in one resource pool as an example. This embodiment is also applicable when PRS is extended to more than one resource pool. For each SL resource pool, the contents discussed in this embodiment can be considered separately or comprehensively.

Case 1: PRS repetition

Case 1.1: Reuse the re-transmission reservation of SCI

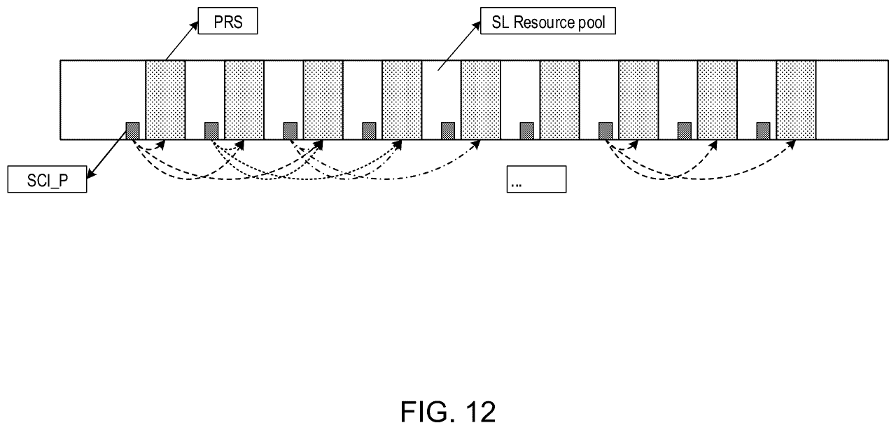

FIG. 12 shows all PRS repetitions with SCI_P indication.

Within a certain time domain (e.g., 32 slots), PRS can be indicated by SCI_ P. In some implementations, the maximum number of transmissions of PRS indicated by SL SCI is 3. However, the number of PRS repetitions is not limited to 3. If the SCI re-transmissions reservation is used here, each PRS can be indicated by the SCI_ P from the previous one or two transmissions as shown in FIG. 12.

Case 1.2: one SCI_P indicating multiple repetitions of PRS

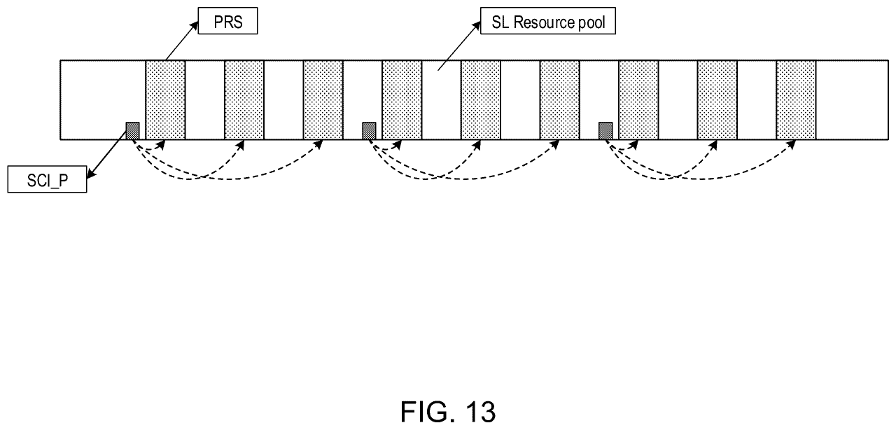

FIG. 13 shows only the first PRS repetitions with SCI_P indication.

Within a certain time domain, PRS can be indicated by SCI_P, and the maximum number of transmissions of PRS indicated by SL SCI is 3. In order to reduce some repetitions of SCI_P, only one SCI_P is used to indicate three repetitions of PRS, as shown in FIG. 12. In another implementations, to be a PRS pattern one SCI_P can be used to indicate more than three repetitions of PRS, with a fixed gap between adjacent PRSs.

Case 2: Periodic PRS

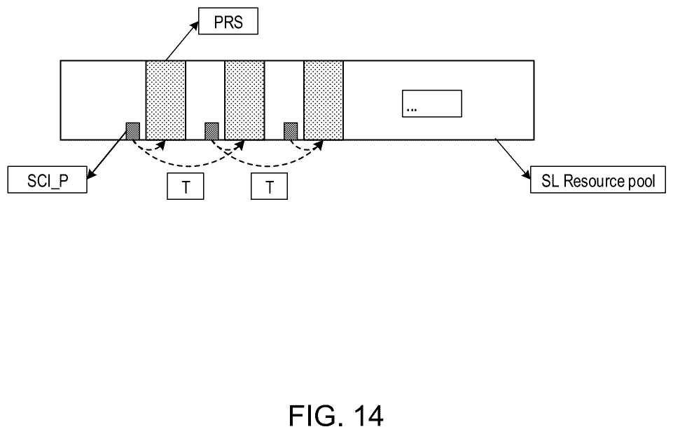

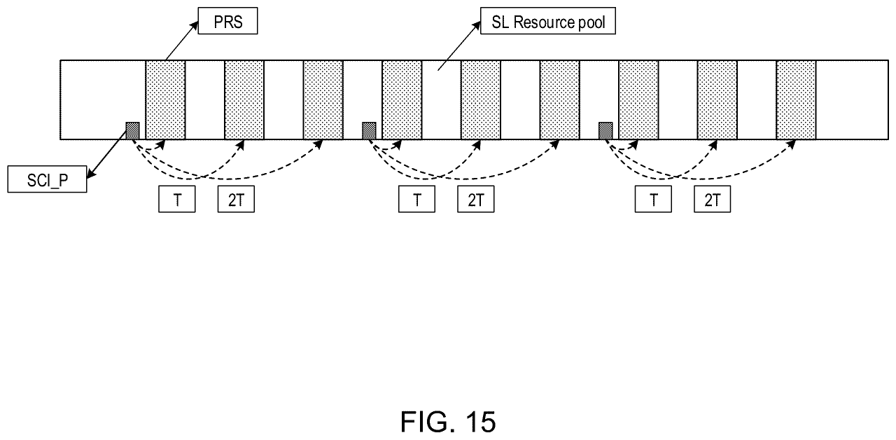

FIG. 14 shows each PRS cycle with SCI_P indication. FIG. 15 shows every three PRS cycles with one SCI_P indication.

In order to reduce some SCI_P, for a periodic PRS transmission, one SCI_ P may be used to indicate PRS of N cycles. If N is equal to one, the case is the same as original scheme in SL, as show in FIG. 14. If N is equal to three, the case could reduce two SCI_P every three PRS cycles to compared with the original scheme, as shown in FIG. 15.

Case 2.1: In one example, when N=1, each PRS needs a SCI_P to indicate.

Case 2.2: In another example, when N=3, three PRSs only need one SCI_P to indicate.

Case 3: Periodic PRS and repetition permutation combination

In some implementations, the above two cases for repeated PRS transmissions and periodic PRS transmissions can be combined. For example, when repeated PRSs use the scheme discussed in Case 1.1, the periodic PRS transmissions may use the scheme of Case 2.1 or Case 2.2. When the repetition of PRS uses the scheme of Case 1.2, there are also two schemes for periodic PRS transmissions.

The above schemes in Case 1 and Case 2 can also be applied to the case where PRS exceeds one resource pool and to this case.

The disclosed technology can be implemented in some embodiments such as Case 3 can provide the permutation combination scheme, for example when PRS exceeds one resource pool.

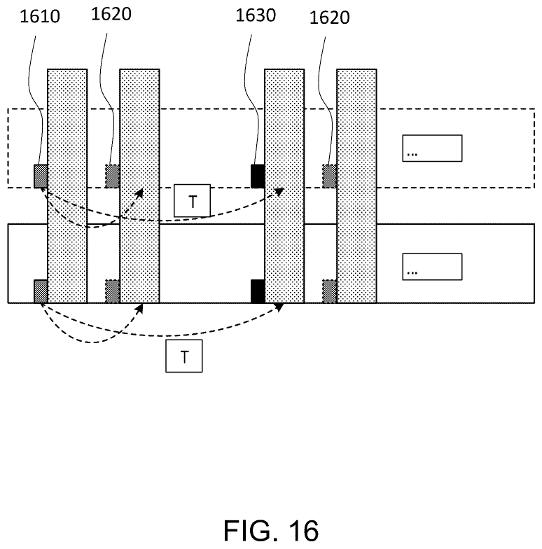

FIG. 16 shows a permutation combination scheme.

Case1: As shown in FIG. 16, if only SCI_P 1610 is used to indicate PRS, more than one cycle and repeated PRS transmission can be indicated by one SCI_ P.

Case2: As shown in FIG. 16, if only SCI_P 1610 and SCI_P 1630 are used to indicate PRS, cach cycle of PRS transmission needs a SCI_P indication for reserving, and the PRS of the repetition does not use the SCI_P indication.

Case3: As shown in FIG. 16, if use all the SCI_P 1610, 1620, 1630 are used to indicate PRS, cach cycle of PRS transmission and each repetition of PRS use the SCI_P indication.

Case4: As shown in FIG. 16, if only SCI_P 1610 and SCI_P 1620 are used to indicate

PRS, more than one cycle of PRS transmission can be indicated by one SCI_P, and each repetition of PRS needs a SCI_P indication.

### Example Embodiment 4: SCI_P Frequency Hopping, within a Resource Pool, or Between Resource Pools, to Improve Performance

For the original SL resource selection scheme, PSCCH/PSSCH generally does not occupy the whole resource pool or the whole BWP bandwidth. When using mode 2 selecting method to select resources, the selected resources of different re-transmission resource locations can be in different sub-channels from the location of an initial transmission or a previous re-transmission. Therefore, a diversity gain can improve the multipath effect and address issues associated with interferences on receptions at different frequencies to some extent.

For SL PRS, the range of a frequency domain for each repetition usually takes all of the sub-channels in a resource pool by a pre-configuration or a dynamic indication, and the transmission range of SL PRS for each repetition in the frequency domain is almost the same.

In some cases that SL PRS is indicated by SCI_P, and if the original SL scheme in which PSCCH is within the sub-channel, which is lowest frequency range of the starting sub-channel of PSSCH frequency domain, is used, SCI_P may be in the first sub-channel from the low frequency of a SL resource pool. This scheme may reduce the consumption of detecting SPCI.

The frequency domain of SCI_P that does not change for some repetitions of PRS and SCI_P, which will affect SCI_P receptions, may eventually lead to a poor reception of SL PRS.

Therefore, in order to receive SCI_P better and make full use of the frequency domain diversity gain of SCI_P, multiple SCI_Ps can be used for one SL PRS. In addition, the frequency domain of SCI_P corresponding to different repetitions of PRS can be flexibly adjusted. The frequency domain of the SCI_P transmission can be in one resource pool, in different resource pools, or not in the range of SL resource pool. For example, the special band for SCI_P in Case 2.3 of Example Embodiment 2 may also apply to one SCI indicating multiple SL PRS repetitions.

In a case that the PRS indicates the SL PRS through an SCI in a resource pool, and cach SL PRS has a SCI_P indication, SCI_P may improve its reception performance through a frequency modulation.

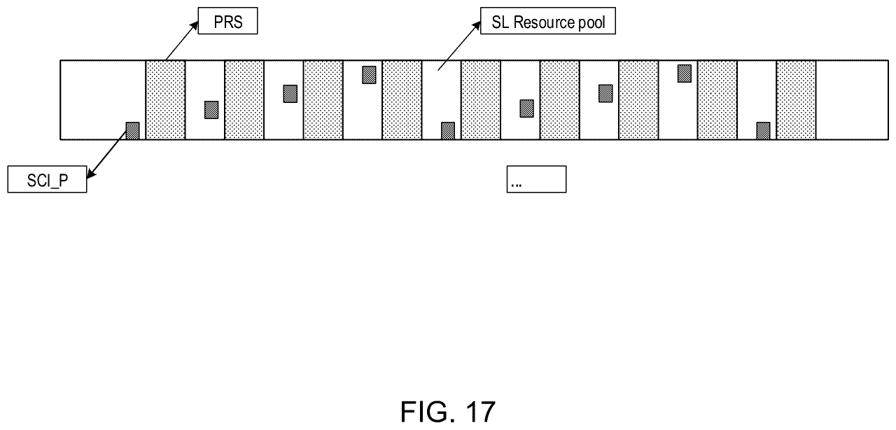

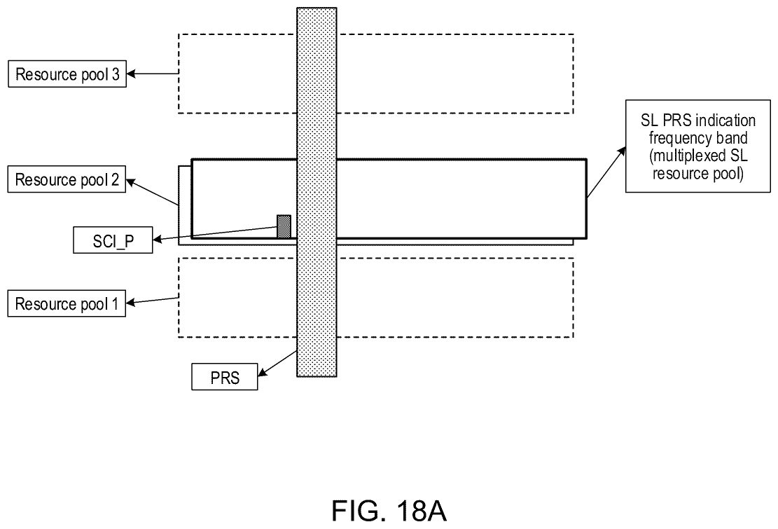

FIG. 17 shows a frequency hopping indication of SCI_P.

As shown in FIG. 17, for PRS with different repetitions, SCI_P varies among different sub-channels in the resource pool (e.g., sub-channels can be selected randomly, and sub-channels with better channel conditions can be selected according to some measurements/indication information, or sub-channels can be selected by polling according to certain rules and/or according to a pre-configuration, etc.). In addition, the time and frequency domain positions of SCI_Ps, which indicates PRS, are not fixed with respect to a PRS.

On the other hand, if the frequency domain of SCI_P is fixed in one resource pool (or out of a resource pool), and there is only a detection of SCI_P on some fixed subchannels, the repetitions and complexity of blind detection can be reduced.

### Example Embodiment 5: Considering PRS Communication, the Resource Selection Scheme Related to PRS Mode2

As discussed above, there are many possibilities for SCI_P to indicate SL PRS in combination with the (bound/unbound) relationship of SL resource pool. In some implementations, the SL PRS mode 2 method from the original SL mode 2 resource selection scheme can be applied to the cases discussed in this patent document.

Case 1: PRS mode 2 Sensing

In some implementations, mode2 for SL PRS can be used. In some implementations, the first step is a sensing operation. A sensing operation in SL indicates receiving or obtaining RSRP of PSCCH/PSSCH. For SL PRS, the sensing RSRP may be measured from SCI_P or SL PRS. In some implementations, which reference signal is used to measure RSRP may be determined based on a high-level configuration or predefined, explicit or implicit dynamic indication.

In some implementations, when one SCI_P indicates multiple PRSs, the corresponding mode 2 sensing can determine whether the resource is occupied by measuring the RSRP from PRS and/or SPCI and comparing the preset RSRP threshold of the PRS.

Case 2: Separate mode 2 PRS resource selection method

The original NR PRS is pre-configured and directly dispatched by a base station (BS). Other receiving devices can directly obtain it from the corresponding location without sensing. For the SL PRS resource selection of mode 2, the base station does not participate in the resource allocation, and the transmitting equipment needs to monitor the channel and transmit with available resources.

Here, it is assumed that SL PRS and SL are not in the same frequency band. For instance, SL PRS is transmitted on an unlicensed spectrum. That is, the signals transmit in SL resource pools such as PSCCH/PSSCH will not affect the transmission of SL PRS, and only the influence of other PRSs in the system should be considered. In the frequency domain where there is no shared frequency band between PRS and SL resource pool, only PRS sensing is required.

Case 2.1: PRS mode 2 sensing window length in time domain

In order to avoid the reserved resource location of other PRS during resource selection, from the perspective of time domain, the cycle of SL PRS/PRS transmission and transmission delay and other issues need to be considered. Taking the transmission period of NR PRS as an example, the scheme of the length of PRS sensing window on a time domain will be discussed below.

The cycle range of PRS is quite different from that of PSSCH given by parameter-sl-resourcereserveperiod-r16 in the current standard (e.g., 38.331). For example, the period of PRS can be 10240 ms, while the maximum data period of current protocol PSCCH/PSSCH is 1000 ms. Therefore, 100 ms and 1100 ms in-sl-sensingwindow-r16 used for two types of PSSCH cycles are no longer applicable.

Scheme: Quantize the PRS period values into n levels, and the values corresponding to quantization levels are optional sensing window lengths for PRS.

For example, the cycle range that PRS can adopt is: {4, 5, 8, 10, 16, 20, 32, 40, 64, 80, 160, 320, 640, 1280, 2560, 5120, 10240}

In an implementation, when n equals 1, it is necessary to meet the sensing requirements of all PRS cycles, and the length of PRS sensing length should be at least 10240 ms (it can be equal regardless of processing delay). For example, 10241 or 10250 or other values bigger than 10240 can be selected as the sensing window length.

In another implementation, when n equals 2, two sensing window lengths can be selected for PRS. For example, if the PRS cycle is less than 320 ms, one PRS sensing window length is adopted, such as 321 ms; if PRS bigger than 320 ms, another PRS sensing window length will be adopted, such as 10241 ms.

In another implementation, when the value of n is the number of all candidate cycles of PRS, all PRS cycles have their own corresponding resource selection window lengths. When the PRS cycle in the system is only 4 ms, the sensing window length of PRS can be 5 ms, which can satisfy the corresponding sensing requirements.

Case 2.2: PRS mode2 Sensing window Frequency domain

In order to avoid the reserved resource location of other PRS during resource selections, from the perspective of frequency domain, it is necessary to consider the existence of other PRS or other interference signals/channels in the frequency domain of SL PRS currently transmitted.

Scheme: The frequency domain range of PRS mode2 sensing window can be all the frequency bands occupied by the currently transmitted SL PRS, or part of the frequency band range with low interference/no related signal interference being excluded according to a high-level signaling or another pre-configured/displayed/implied indication/measurement feedback.

In some implementations, the frequency domain range of the PRS mode 2 sensing window can be all the frequency bands occupied by the currently transmitted SL PRS, or it can exclude some low-interference/no correlation according to a high-level signaling or another pre-configured/displayed/implicit indications/measurement feedback, etc.

Case 2.3: PRS mode 2 selection windows

The resource selection window for PSCCH/PSSCH is per SL resource pool, and the time domain lengths of selection windows can be affected by the packet delay budget (PDB).

Scheme: For the resource selection window of SL PRS, the frequency domain should be related to the frequency domain range actually sent by PRS, and the delay requirements of SL PRS should be considered in the time domain. For example, after the request of target UE, in order to ensure the timeliness of positioning reference signals, there are certain delay requirements for sending SL PRS.

In case of periodic SL PRS, the length of selection windows should not exceed the total duration of the SL PRS indicated by one SCI_P. For example, if cach SL PRS has a SCI_P indication, the resource selection window of SL PRS should be guaranteed to end before the next SL PRS is sent at the last moment. That is, the selection window should be completed before the arrival of the next SL PRS, and a sufficient processing delay should be reserved.

Solution: If it is a periodic SL PRS, the total duration of the SL PRS indicated by one SCI_P should not exceed. (e.g., cach SL PRS has an SCI_P indication, then the last moment of the resource selection window of the SL PRS must be guaranteed before the next SL PRS is sent, that is, the selection window must be guaranteed to end before the next SL PRS, and enough processing is reserved).

Case 3: mode 2 PRS resource selection method (consider the impact of SL PSCCH/PSSCH)

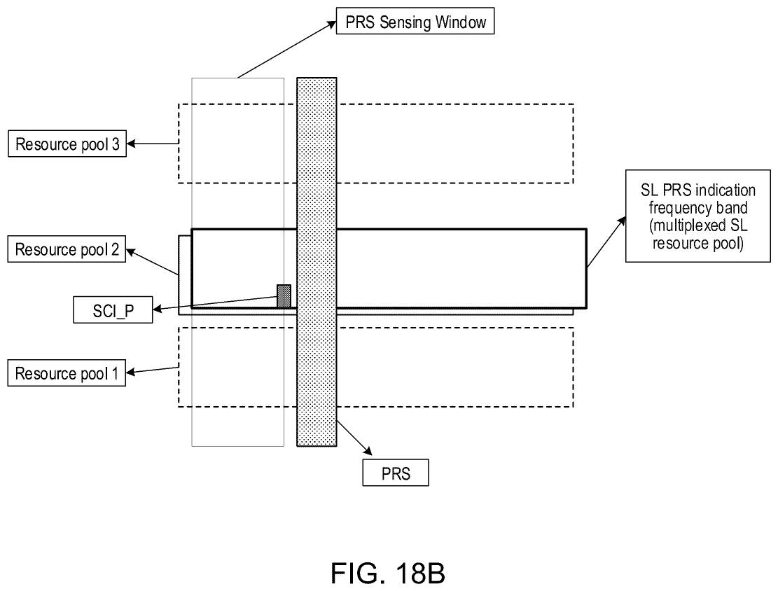

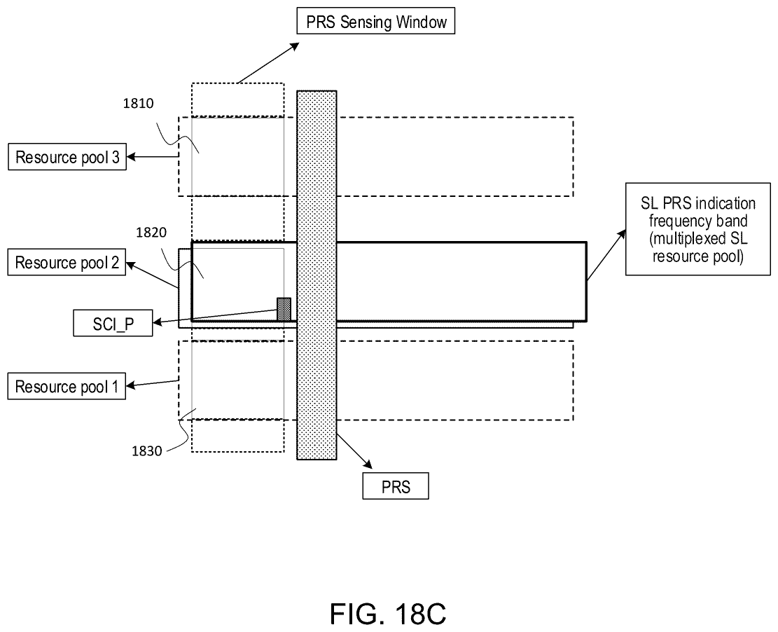

FIG. 18A shows windows of SL PRS mode 2 resource selection method. FIG. 18B shows a PRS sensing window. FIG. 18C shows a plurality of portions 1810, 1820, 1830 of a PRS sensing window.

When selecting mode2 resources allocation method for SL PRS, the impact of resource occupation of SL PSCCH/PSSCH on SL PRS should be considered.

Through the analysis of detailed example 1 and 2, there are many possibilities for the indication of SL PRS by SCI_P, combined with the (binding/unbound) relationship of SL resource pool. Here, only one case is taken as an example to illustrate the mode2 scheme of SL PRS, which is also applicable to other cases, such as the PRS without SCI_P indication and so on.

Sensing window are as below.

First, the equipment or communication device transmitting SL PRS needs to know whether there are other SL PRS transmissions or reservation/occupation, etc. This can be achieved through the separate mode 2 PRS resource selection method described in Case 2. As shown in FIG. 18, SL PRS has a special indication frequency band coincided with the resource pool 2. That is, the transmission of SL PRS can be obtained through SCI_P monitoring of this frequency band, which can be referred to as SL PRS sensing windows.

In addition, the sensing window of the device needs to include the SL signals/channels such as PSCCH/PSSCH in all SL resource pools touched by or in contact with SL PRS. As shown in FIG. 18, the device needs to sense resource pool 1, resource pool 2 and resource pool 3. These sensing windows are configured in each resource pool according to its resource pool configuration.

In an implementation, the final SL PRS sensing window can be a combination of the above two types of sensing windows.

In another implementation, the final SL PRS sensing window covers at least the above two types of sensing windows in time-frequency domain.

In another implementation, in the time-frequency domain, according to the relevant information of each resource pool/frequency band/time period (the information can come from the high-level indication/pre-configuration/PC5 RRC/MAC CE/dynamic/explicit/implicit indication), the final SL PRS sensing window can include part of the above sensing windows or a combination of sensing windows as the final sensing window.

In an implementation, the final SL PRS sensing window can be a combination of the above two types of sensing windows.

In another implementation, the final SL PRS sensing window covers at least the above two types of sensing windows in time-frequency domain.

In another implementation, the final SL PRS sensing window can be selected in the time-frequency domain according to the relevant information of each resource pool/frequency band/period (the information can be from high-layer indication/pre-configuration/RRC/MAC CE dynamic/dominant/recessive indication). Part of the sensing window, or a combination thereof, can be selected as the final sensing window.

This scheme can be extended in different ways of indicating SL PRS by SCI_P and the relationship between different PRS and SL resource pool.

Selection windows: when considering the influence of SL PSCCH/PSSCH, the selection windows of mode 2 SL PRS meet the same conditions as the separate mode 2 PRS sensing window.

### Example Embodiment 6: Considering PRS Communication, the Resource Selection Scheme Related to SL PSCCH/PSSCH Mode2

After introducing SL PRS into SL, the impact on mode 2 mainly involves the sensing window and resource selection window of PSCCH/PSSCH, as well as the sensing window and resource selection window of SL PRS. In Example Embodiment 5, the sensing window and resource selection window related to SL PRS are briefly described. This embodiment mainly analyzes the mode 2 scheme of PSCCH/PSSCH for the equipment in the resource pool.

In the absence of PRS, as the original SL mode 2 method, PSCCH/PSSCH should be monitored in the resource pool to determine whether there are other resources reserved. After adding SL PRS, the PSCCH/PSSCH sent by the device is still in the resource pool. That is to say, it is still necessary to maintain the original sensing window range, and at the same time, it is necessary to determine whether there is reserved occupation of SL PRS resources, including periodic and non-periodic occupation. Therefore, it is necessary to optimize the sensing window of PSCCH/PSSCH.

Case 1: mode 2 PSCCH/PSSCH resource allocation without PRS (does not consider the impact of SL PRS)

Without considering SL PRS, the mode 2 scheme of PSCCH/PSSCH does not need to be modified. The original scheme is still maintained. Transmission is performed in each resource pool and available resources are selected.

Case 2: mode 2 PSCCH/PSSCH resource allocation with SL PRS (consider the impact of SL PRS)

Through the analysis of Example Embodiment 2 and Example Embodiment 3, there are many possibilities for the indication of SL PRS by SCI_P, combined with the (binding/unbound) relationship of SL resource pool. Here, only one case is taken as an example to illustrate the mode 2 scheme of SL PRS, which is also applicable to other cases, such as the PRS without SCI_P indication and so on (FIG. 18C also shows a case of the windows of SL PSCCH/PSSCH mode2 resource selection method, same as a part of the windows of PRS).

Sensing windows are as below.

First, the equipment or communication devices transmitting PSCCH/PSSCH need to sense, detect or monitor in its own SL resource pool. Here, without considering the SL PRS in the process, the sensing window is the original sensing windows of SL resource pool.

Second, the device sending PSCCH/PSSCH needs to know whether there are SL PRSs in the resource pool. This can be achieved through the separate mode 2 PRS resource selection method described in Case 2.

As shown in FIG. 18, assuming that the UE is triggered to send PSCCH/PSSCH on resource pool 2, the UE first needs to send the PSCCH/PSSCH signal/channel in the resource pool according to the parameters of the resource pool in resource pool 2. Second, the UE needs to sense whether there are SL PRSs in the resource pool. At this time, the UE needs to sense according to the independent sensing scheme of SL PRS within the frequency domain where the SCI_P is located.

For the example, as shown in FIG. 18, since the SCI_P sensing domain of the UE multiplexes the SL resource pool 2, the frequency domain of the two kinds of sensing required by the UE coincides. In the time domain, the period of PSCCH/PSSCH in the resource pool and the period of SL PRS related to the frequency band need to be considered respectively.

If it is a UE transmission on resource pool 3, the PSCCH/PSSCH needs to be sensed on resource pool 3. In addition, the SCI_P in resource pool 2 needs to be sensed according to the sensing window length of SL PRS separate sensing.

In an implementation, the final SL PSCCH PSSCH sensing window can be the combination of the above two kinds of sensing windows.

In another implementation, the final SL PSCCH/PSSCH sensing window covers at least the above two types of sensing windows.

In another implementation, in the time-frequency domain, according to the relevant information of each resource pool/frequency band/time period (the information can come from the high-level indication/pre-configuration/PC5 RRC/MAC CE/dynamic/explicit/implicit indication), the final SL PSCCH/PSSCH sensing window can include part of the above sensing windows or a combination thereof can be selected as the final sensing window.

This scheme can be extended in different ways of indicating SL PRS by SCI_P and the relationship between different PRS and SL resource pool.

Selection windows: when considering the influence of SL PRS, the selection windows of mode2 SL PSCCH/PSSCH are the same as those of the original SL mode 2 sensing window.

### Example Embodiment 7: After Adding PRS, Comprehensively Consider the Resource Selection Scheme Related to SL Mode 2

After the introduction of SL PRS, the overall SL mode2 processing scheme, except for the independent resource allocation scheme for PSCCH/PSSCH and PRS (e.g., scheme 1 below: adopt two sets of different sensing windows and resource selection windows), it can also comprehensively consider PSCCH/PSSCH and SL PRS, and process their sensing windows/resource selection windows in a unified manner (scheme 2 below). That is, whether the device wants to transmit SL PRS or PSCCH/PSSCH, the same transmission window and/or resource selection window can be used.

Case 1: comprehensively consider SL mode 2, and implemented in two sets respectively

Scheme 1: when the mode2 resource selection is triggered, the corresponding sensing and/or selection window is selected for execution according to different types.

In some implementations, when triggering the resource selection of SL PRS at time n, only the sensing window and selection window of the SL PRS are used.

In some implementations, when triggering the resource selection of PSCCH/PSSCH at time n, only the sensing window and selection window of the optimized PSCCH/PSSCH are used.

Case 2: comprehensively consider SL mode 2, and implemented in one set

Scheme 2: comprehensively consider PSCCH/PSSCH and SL PRS, and handle the sensing window/selection windows together, including unified sensing/selection window time domain and/or frequency domain.

Case 2.1: Joint consideration of SL sensing window

Time domain of the joint SL Sensing window

In order to avoid the reserved resource location of other PRS during resource selection, from the perspective of time domain, the cycle of SL PRS/PRS transmission delay and other issues need to be considered. In order to avoid that the time domain length of the original SL sensing window cannot cover some large PRS cycles when it is used as a unified window length, the time domain length of the sensing window should be modified appropriately.

The cycle range of PRS is quite different from that of PSSCH given by parameter-sl-resourcereserveperiod-r16 in 38.331. For example, the period of PRS can be 10240 ms, while the maximum data period of current protocol PSCCH/PSSCH is 1000 ms. Therefore, 100 ms and 1100 ms in-sl-sensingwindow-r16 used for two types of PSSCH cycles are no longer applicable.

In the time domain of PSCCH/PSSCH sensing window, according to the current standard (e.g., 38.331), the maximum period of PSCCH/PSSCH is 1000 ms, and the cycle range of PRS is quite different from that of PSSCH given by parameter sl-resourcereserveperiod-r16 in the current standard (e.g., 38.331).

For example, the period of PRS can be 10240 ms, so the sensing window length used for the two types of PSSCH cycles is no longer applicable. That is, 100 ms and 1100 ms in-sl-sensing window-r16 are no longer applicable. Therefore, it is necessary to comprehensively consider that the sensing length of PSCCH/PSSCH is applicable to the sensing length of PRS.

Case 2.1.1: joint SL Sensing window (Case1)

Case1: determining the length of PRS sensing windows is an integral multiple of the window length of PSCCH/PSSCH, such that: L_{PRS}=nL_{PSSCH}. The lengths of sensing windows are the lengths of the PRS pattern in time domain.

Alternatively, according to Scheme 1 above, only when transmitting PRS, the sensing is n times the PSCCH/PSSCH sensing window length. When only PSCCH/PSSCH is selected in mode2 resources, it is still adopted according to the normal sensing window length.

N can be flexibly adjusted according to the PRS cycle in the system.

In one example, when the period of PSCCH/PSSCH is less than 100 ms, the sensing window length of PSCCH/PSSCH is 100 ms. Here, if the period of SL PRS is also less than 100 ms, n can be 1.

In another example, when the period of PSCCH/PSSCH is less than 100 ms, the sensing window length of PSCCH/PSSCH is 100 ms. Here, if the PRS period is 640 ms, n can be 7.

This scheme may not only meet the demand for PRS, but also ensure the least monitoring as much as possible, which is beneficial to power consumption.

Case 2.1.2: joint SL sensing window (Case2)

Case2: PRS and PSCCH/PSSCH adopt the same sensing window length when trigger mode 2 resources selection.

Expression 1: Max {PSCCH/PSSCH period+X, PRS period+X}

Here, at least the x must be bigger than the procedure delay. If the PSCCH/PSSCH period is less than 99 ms, the window length is 100 ms, i.e., X is at least 1 ms.

For example, when the period of PSCCH/PSSCH is less than 100 ms and the period of PRS is 640 ms, the sensing window length adopted is the period of PRS plus x, which can be taken as 640+X.

Expression 2: Max {PSCCH/PSSCH sensing window length, PRS independent sensing window length}

For example, when the sensing window length of PSCCH/PSSCH is 100 ms and the separate (resource pool) sensing window of PRS is 650 ms, the sensing window length of PSSCH/PSCCH and PRS in mode2 resource selection should adopt Max {100, 650}, that is, the sensing window length is 650 ms.

Expression 3: one value of the set {P1, . . . , 100, . . . , P2, . . . , 1100, . . . , P3, . . . }

According to the existing protocol, the currently configurable maximum cycle size of PRS is considered. For example, when the PRS cycle is 10240 ms, P3 can be 10241 ms or other values bigger than or equal to 10240 ms.

In some implementations, it can also be determined according to the current actual SL PRS period. For instance, the maximum period of actual transmission SL PRS in the system is 2560 ms, the time domain size of the sensing window can be P2, the value of P2 can be 2561 ms.

The main purpose of the time domain length of the resource selection window is to ensure that the occupation and reservation of PRS and data can be monitored in the smallest selection window.

The disclosed technology can be implemented in some embodiments to use SCI_P to indicate SL PRS and provide different structures for SCI_P.

The disclosed technology can be implemented in some embodiments to use different SCI_P method to indicate different SL PRS on a frequency domain.

The disclosed technology can be implemented in some embodiments to consider SL PRS and perform operations associated with SL PRS mode2 resource allocation by monitoring RSRP, sensing window, and/or selection window.

The disclosed technology can be implemented in some embodiments to consider SL PRS and SL PSCCH/PSSCH and perform operations associated with mode2 resource allocation of SL PRS, and SL PSCCH/PSSCH by monitoring sensing window and/or selection window.

The disclosed technology can be implemented in some embodiments to provide SCI_Ps that indicate one SL PRS in different resource pools on a frequency domain, in order to receive PSCCH/PSSCH efficiently.

The disclosed technology can be implemented in some embodiments to use partial sensing schemes on a frequency domain for different resource pools.

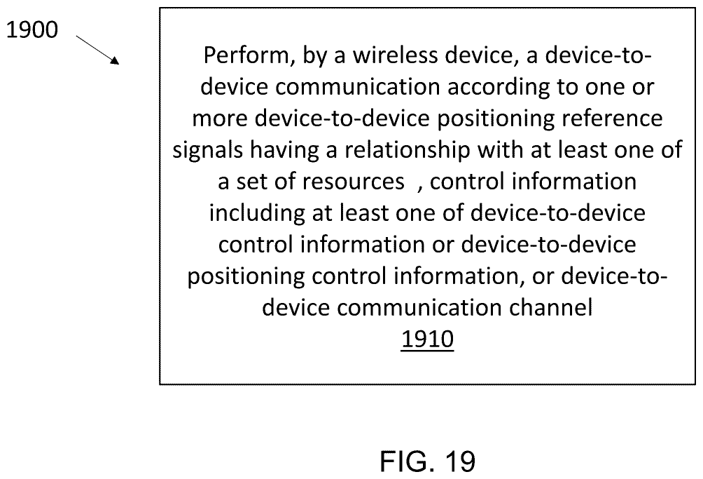

FIG. 19 shows an example of a process for wireless communication based on some example embodiments of the disclosed technology.

In some implementations, the process 1900 for wireless communication may include, at 1910, performing, by a wireless device, a device-to-device communication according to one or more device-to-device positioning reference signals having a relationship with at least one of a set of resources, control information including at least one of device-to-device control information or device-to-device positioning control information, or device-to-device communication channel.

In some implementations, the one or more device-to-device positioning reference signals may include a positioning reference signal (PRS) such as a sidelink positioning reference signal (SL PRS). In some implementations, the device-to-device control information may include sidelink control information (e.g., SCI, SCI_P, SL SCI, SPCI, etc.).

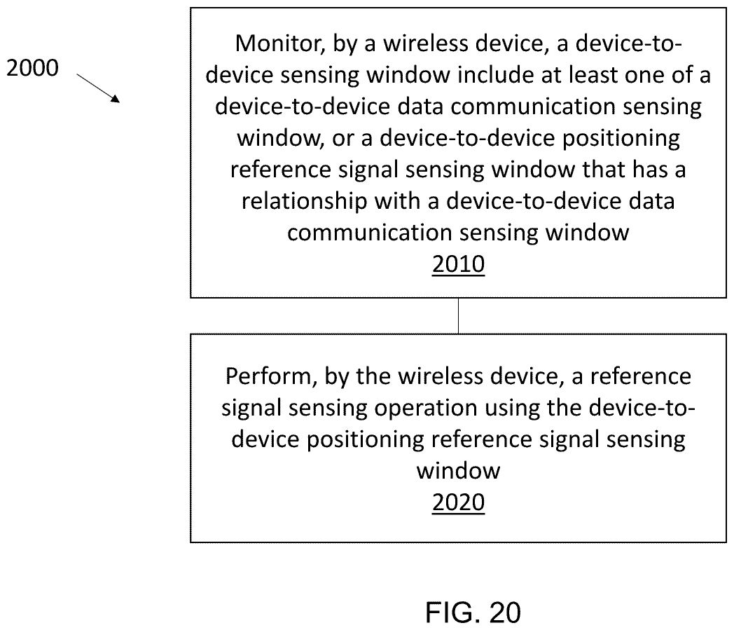

FIG. 20 shows another example of a process for wireless communication based on some example embodiments of the disclosed technology.

In some implementations, the process 2000 for wireless communication may include, at 2010, monitoring, by a wireless device, a device-to-device sensing window include at least one of a device-to-device data communication sensing window, or a device-to-device positioning reference signal sensing window that has a relationship with a device-to-device data communication sensing window, and at 2020, performing, by the wireless device, a reference signal sensing operation using the device-to-device positioning reference signal sensing window.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following

solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: performing, by a wireless device, a device-to-device communication according to one or more device-to-device positioning reference signals having a relationship with at least one of a set of resources, control information including at least one of device-to-device control information or device-to-device positioning control information, or device-to-device communication channel.

In some implementations, the one or more device-to-device positioning reference signals may include a positioning reference signal (PRS) such as a sidelink positioning reference signal (SL PRS). In some implementations, the device-to-device control information may include sidelink control information (e.g., SCI, SCI_P, SL SCI, SPCI, etc.).

Clause 2. The method of clause 1, wherein the device-to-device control information includes at least one of: sidelink control information (SCI), and the device-to-device positioning control information includes sidelink positioning control information (SPCI) that indicates a positioning reference signal.

Clause 3. The method of any of clauses 1-2, wherein the one or more device-to-device positioning reference signals having the relationship with the set of resources include a reference signal that is inside a set of sidelink resources.

Clause 4. The method of any of clauses 1-2, wherein the one or more device-to-device positioning reference signals having the relationship with the set of resources include a reference signal that exceeds a frequency-domain boundary of the set of resources and at least partially overlaps with the set of resources.

Clause 5. The method of any of clauses 1-2, wherein the one or more device-to-device positioning reference signals having the relationship with the set of resources include a reference signal that exceeds a frequency-domain boundary of the set of resources and at least partially overlaps with resources of two or more sets of resources.

Clause 6. The method of any of clauses 1-2, wherein the one or more device-to-device positioning reference signals having the relationship with the set of resources include a reference signal that is outside a set of sidelink resources.

Clause 7. The method of any of clauses 1-6, wherein the one or more device-to- device positioning reference signals having the relationship with the device-to-device control information include one or more device-to-device positioning reference signals indicated by the device-to-device control information.

Clause 8. The method of clause 7, wherein the device-to-device positioning reference signal or the control information is at least partially inside a set of sidelink resources.

Clause 9. The method of clause 7, wherein the device-to-device positioning reference signal or the control information is at least partially outside a set of sidelink resources.

Clause 10. The method of clause 1, wherein the control information includes a sidelink positioning control information (SPCI) segment that indicates a plurality of positioning reference signals (PRSs).

Clause 11. The method of clause 1, wherein the control information includes a plurality of SPCI segments that indicates a PRS, wherein each SPCI segment indicates the PRS.

Clause 12. The method of clause 11, wherein the SPCI segments come from different resource sets including at least one of the sets of resources covered by the PRS.

Clause 13. The method of clause 1, wherein the control information includes the plurality of SPCI segments indicates different portions of the PRS.

Clause 14. The method of clause 13, wherein the plurality of SPCI segments is in different sets of resources, and wherein each of the plurality of SPCI segments indicates portions of the PRS in the set of resources cach SPCI segment is on.

Clause 15. The method of clause 1, wherein a PRS is pre-configured without being indicated by an SCI.

Clause 16. The method of clause 1, wherein the one or more device-to-device positioning reference signals having the relationship with the device-to-device communication channel, include a sidelink reference signal configured with at least one of physical sidelink control channel (PSCCH) or physical sidelink shared channel (PSSCH).

Clause 17. The method of clause 16, wherein cach PSCCH or PSSCH corresponds to at least one PRS.

Clause 18. The method of clause 16, wherein a plurality of PSCCHs or PSSCHs corresponds to a PRS.

Clause 19. The method of clause 1, further comprising: receiving, by the wireless device, a first information by performing a sensing operation; and performing, by the wireless device, at least one of PSCCH resource selection, PSSCH resource selection, or PRS resource selection.

Clause 20. The method of clause 19, wherein the first information includes at least one of SPCI that indicates PRS, SCI that indicates PRS, SCI transmitted on PSCCH to indicate PSSCH, or PRS.

Clause 21. The method of clause 19, wherein, in a case that a frequency domain range of PRS is within a bandwidth of the set of resources, both SPCI and PRS are located in the set of resources.

Clause 22. The method of clause 19, wherein the one or more device-to-device positioning reference signals are associated with at least one of PSCCH, PSSCH or the first information.

Clause 23. The method of clause 19, wherein at least one of a channel busy ratio (CBR), a channel occupancy ratio (CR), a high-level signaling indication, or a measurement feed-back is used to determine whether the first information indicates a PRS.

Clause 24. The method of any of clauses 21-23, wherein the PRS exceeds a frequency-domain boundary of the set of resources and at least partially overlaps with the set of resources.

Clause 25. The method of clause 19, wherein, in a case that a frequency domain range of device-to-device positioning reference signal exceeds a bandwidth of a single device-to-device resource set, the one or more device-to-device positioning reference signals are distributed among two or more device-to-device resource sets and resources between adjacent device-to-device resource sets.

Clause 26. The method of clause 19, wherein an SPCI for a PRS or portions of the PRS is capable of being out of a single device-to-device resource set.

Clause 27. The method of clause 24, wherein a same number of SPCI segments are used for each resource pool.

Clause 28. The method of clause 24, wherein the PRS partially overlaps with the set of resources at a plurality of portions of the PRS, and wherein SPCI in each set of resources indicates the PRS or each of the portions of the PRS overlapping with the set of resources, respectively.

Clause 29. The method of any of clauses 19-28, wherein the first information includes information associated with uplink or downlink transmissions or sidelink transmissions.

Clause 30. The method of any of clauses 19-28, wherein at least one of the first information or the one or more device-to-device positioning reference signals is received or transmitted or received and transmitted through unlicensed frequency band or licensed band.

Clause 31. The method of clause 30, wherein the unlicensed frequency band includes an intelligent transportation system (ITS).

Clause 32. The method of any of clauses 1-31, wherein a frequency band of the one or more device-to-device positioning reference signals is obtained through at least one of: pre-configuration, radio resource control (RRC) signaling, medium access control (MAC) control element (MAC CE), device-to-device control information (SCI) or downlink control information (DCI).

Clause 33. The method of any of clauses 19-32, wherein the first information further indicates a number of repetitions of at least one of the device-to-device positioning reference signals.

Clause 34. The method of any of clauses 19-32, wherein repeated transmissions of the device-to-device positioning reference signals are performed periodically, and wherein the first information further indicates a transmission cycle of the repeated transmissions of the device-to-device positioning reference signals.

Clause 35. The method of clause 19, wherein the performing of the at least one of PSCCH resource selection, PSSCH resource selection, or PRS resource selection includes measuring at least one of a reference signal received power (RSRP) of the PRS signal, RSRP of SPCI, RSRP of PSSCH, or PSRP of PSCCH when monitoring a sensing window for the resource selection.

Clause 36. The method of clause 35, wherein the sensing window includes a time-domain window, and a length of the time-domain window is determined by: dividing a period set of the PRS into a plurality of set values; and selecting one of the plurality of values as the length of the time-domain window.

Clause 37. The method of clause 35, wherein the sensing window includes a frequency-domain window that includes a frequency band occupied by a currently transmitted device-to-device positioning reference signal or part of a frequency band range with an interference higher than a predetermined threshold value or the frequency band includes at least one of SCI or SPCI.

Clause 38. The method of clause 37, wherein in a case that a dedicated resource domain or an unlicensed spectrum is used, the frequency band of SPCI is outside the frequency range of a transmission of PRS or a set of sidelink resources, and PRS is obtained according to at least one of SCI or SPCI by performing a sensing operation.

Clause 39. The method of clause 19, further comprising: selecting a device-to-device communication resource out of a device-to-device resource domain within a resource selection window; performing a device-to-device data communication based the selected resource, wherein a time-domain length of the resource selection window does not exceed at least a delay or a period or the delay and the period of a periodic transmission indicated by at least one of: pre-configuration, radio resource control (RRC) signaling, medium access control (MAC) control element (MAC CE), device-to-device control information (SCI) or downlink control information (DCI).

Clause 40. The method of clause 39, wherein the resource includes at least one of physical sidelink control channel (PSCCH) or physical sidelink shared channel (PSSCH) or SCI indicating PRS, SPCI or PRS.

Clause 41. A method of wireless communication, comprising: monitoring, by a wireless device, a device-to-device sensing window include at least one of a device-to-device data communication sensing window, or a device-to-device positioning reference signal sensing window that has a relationship with a device-to-device data communication sensing window; and performing, by the wireless device, a reference signal sensing operation using the device-to-device positioning reference signal sensing window.

Clause 42. The method of clause 41, wherein a time-domain length of the device-to-device positioning reference signal sensing window is larger than a time-domain length of the device-to-device data communication sensing window.

Clause 43. The method of clause 41, wherein the device-to-device positioning reference signal sensing window on a frequency domain covers at least one device-to-device data communication sensing window.

Clause 44. The method of any of clauses 41-43, wherein the device-to-device positioning reference signal sensing window includes a sensing window for PRS, and the device-to-device data communication sensing window includes a sensing window for PSCCH or PSSCH.

Clause 45. The method of clause 44, wherein at least one of the device-to-device data communication sensing window or the device-to-device positioning reference signal sensing window is determined based on at least one of: high-level indication, pre-configuration, PC5, RRC, MAC CE, dynamic indication, explicit indication, or implicit indication.

Clause 46. The method of clause 41, wherein a length of the device-to-device positioning reference signal sensing window is obtained by multiplying a length of the device-to-device data communication sensing window by N, where N is a positive number configured according to a predetermined cycle of the device-to-device positioning reference signal sensing window.

Clause 47. The method of clause 41, wherein a time-domain length of the device-to-device positioning reference signal sensing window is equal to a time-domain length of the device-to-device data communication sensing window.

Clause 48. The method of clause 47, wherein the time-domain length of the device-to-device data communication sensing window changes after considering an influence of the device-to-device positioning reference signal.

Clause 49. The method of clause 44, wherein a separate PRS sensing window is used as the device-to-device positioning reference signal sensing window when selecting a resource based on the PRS.

Clause 50. The method of clause 44, wherein a separate PSSCH sensing window is used as the device-to-device data communication sensing window when selecting a resource based on the PSSCH.

Clause 51. The method of clause 44, wherein a single sensing window is used as the device-to-device positioning reference signal sensing window and the device-to-device data communication sensing window when selecting a resource based on both the PRS and PSSCH.

Clause 52. The method of clause 51, wherein the single sensing window used as the device-to-device positioning reference signal sensing window has a same time-frequency domain length as the single sensing window used as the device-to-device data communication sensing window.

Clause 53. The method of any of clauses 49-52, wherein a time domain length of the PRS sensing window is a time domain window length determined by PRS cycle based only on a resource selection of the PRS, or a time domain window length determined by PRS cycle when the PRS and PSSCH resources are selected simultaneously.

Clause 54. The method of any of clauses 49-52, wherein a time domain window length of the PSSCH sensing window is a time domain window length determined based only on a window length of PSSCH resource selection or based on both the sensing window length of PRS and the sensing window length of PSSCH.

Clause 55. An apparatus for wireless communication comprising a processor that is configured to carry out the method of any of clauses 1 to 54.

Clause 56. A non-transitory computer readable medium having code stored thereon, the code when executed by a processor, causing the processor to implement a method recited in any of clauses 1 to 54.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. In some implementations, or additionally, the disclosed components or modules can be implemented as an Application Specific Integrated Circuit (ASIC) and/or as a Field Programmable Gate Array (FPGA) device. Some implementations may additionally or In some implementations include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
performing, by a wireless device, a device-to-device communication according to one or more device-to-device positioning reference signals having a relationship with at least one of a set of resources, control information including at least one of device-to-device control information or device-to-device positioning control information, or device-to-device communication channel.

2. The method of claim 1, wherein the device-to-device control information includes at least one of: sidelink control information (SCI), and the device-to-device positioning control information includes sidelink positioning control information (SPCI) that indicates a positioning reference signal.

3. The method of claim 1, wherein the one or more device-to-device positioning reference signals having the relationship with the set of resources include a reference signal that is inside a set of sidelink resources.

4. The method of claim 1, wherein the one or more device-to-device positioning reference signals having the relationship with the device-to-device control information include one or more device-to-device positioning reference signals indicated by the device-to-device control information.

5. The method of claim 4, wherein the device-to-device positioning reference signal or the control information is at least partially inside a set of sidelink resources.

6. The method of claim 1, wherein the one or more device-to-device positioning reference signals having the relationship with the device-to-device communication channel, include a sidelink reference signal configured with at least one of physical sidelink control channel (PSCCH) or physical sidelink shared channel (PSSCH).

7. The method of claim 1, further comprising:
receiving, by the wireless device, a first information by performing a sensing operation; and
performing, by the wireless device, at least one of physical sidelink control channel (PSCCH) resource selection, physical sidelink shared channel (PSSCH) resource selection, or positioning reference signal (PRS) resource selection.

8. The method of claim 7, wherein the first information includes at least one of SPCI that indicates PRS, SCI that indicates PRS, SCI transmitted on PSCCH to indicate PSSCH, or PRS.

9. The method of claim 7, wherein, in a case that a frequency domain range of PRS is within a bandwidth of the set of resources, both SPCI and PRS are located in the set of resources.

10. The method of claim 7, wherein the one or more device-to-device positioning reference signals are associated with at least one of PSCCH, PSSCH or the first information.

11. The method of claim 7, wherein at least one of a channel busy ratio (CBR) or a channel occupancy ratio (CR) is used to determine whether the first information indicates a PRS.

12. The method of claim 1, wherein a frequency band of the one or more device-to-device positioning reference signals is obtained through at least one of: pre-configuration, radio resource control (RRC) signaling, medium access control (MAC) control element (MAC CE), device-to-device control information (SCI) or downlink control information (DCI).

13. The method of claim 7, wherein the performing of the at least one of PSCCH resource selection or PRS resource selection includes measuring at least one of a reference signal received power (RSRP) of the PRS signal, RSRP of SPCI, RSRP of PSSCH, or PSRP of PSCCH.

14. A method of wireless communication, comprising:
monitoring, by a wireless device, a device-to-device sensing window including at least one of a device-to-device data communication sensing window, or a device-to-device positioning reference signal sensing window that has a relationship with a device-to-device data communication sensing window; and
performing, by the wireless device, a reference signal sensing operation using the device-to-device positioning reference signal sensing window.

15. The method of claim 14, wherein a time-domain length of the device-to-device positioning reference signal sensing window is larger than a time-domain length of the device-to-device data communication sensing window.

16. The method of claim 14, wherein the device-to-device positioning reference signal sensing window on a frequency domain covers at least one device-to-device data communication sensing window.

17. The method of claim 14, wherein a length of the device-to-device positioning reference signal sensing window is obtained by multiplying a length of the device-to-device data communication sensing window by N, where N is a positive number configured according to a predetermined cycle of the device-to-device positioning reference signal sensing window.

18. An apparatus for wireless communication comprising a processor that is configured to carry out a method, the method comprising:
performing, by a wireless device, a device-to-device communication according to one or more device-to-device positioning reference signals having a relationship with at least one of a set of resources, control information including at least one of device-to-device control information or device-to-device positioning control information, or device-to-device communication channel.

19. The apparatus of claim 18, wherein the device-to-device control information includes at least one of: sidelink control information (SCI), and the device-to-device positioning control information includes sidelink positioning control information (SPCI) that indicates a positioning reference signal.

20. The apparatus of claim 18, wherein the one or more device-to-device positioning reference signals having the relationship with the set of resources include a reference signal that is inside a set of sidelink resources.
